(19) United States
(12) Patent Application Publication
(10) Pub. No.: US 2024/0325963 A1
(43) Pub. Date: Oct. 3, 2024

(54) Gas Purification Apparatus with Eductors

(71) Applicant: Streamline Innovations Inc., San Antonio, TX (US)

(72) Inventors: Peter J. Photos, Boerne, TX (US); Cameron Nicolas Lee, San Antonio, TX (US)

(73) Assignee: Streamline Innovations Inc, SAN ANTONIO, TX (US)

(21) Appl. No.: 18/740,982

(22) Filed: Jun. 12, 2024

Related U.S. Application Data
(63) Continuation-in-part of application No. 18/696,192, filed on Jan. 1, 0001.
(63) Continuation-in-part of application No. 18/446,037, filed on Aug. 8, 2023.
Application No. 18/446,037 is a continuation of application No. 17/672,483, filed on Feb. 15, 2022, now Pat. No. 11,931,687.
(60) Provisional application No. 63/401,374, filed on Aug. 26, 2022.
(60) Provisional application No. 63/466,733, filed on May 16, 2023.

(51) Int. Cl. B01D 53/047; B01D 53/04

(52) U.S. Cl. CPC B01D 53/047; B01D 53/0446; B01D 2256/16; B01D 2256/20; B01D 2257/504

(57) ABSTRACT

A system includes an eductor configured to contact an acid gas stream with a primary stream including an aqueous metal chelant and release an eductor outlet stream including CO2 gas and aqueous metal chelant. A chamber is connected to an outlet of the eductor, and the chamber is configured to receive the eductor outlet stream. The chamber includes a sidewall defining a gas outlet and a primary stream outlet such that the chamber is configured to separate the eductor outlet stream into a CO2 gas stream and the primary stream. The eductor includes a motive fluid inlet, and the primary stream extends from the motive fluid inlet to the primary stream outlet such that the primary stream is configured to circulate the aqueous metal chelant from the chamber to the eductor.

### RELATED APPLICATION(S)

This is a Continuation In Part Application of U.S. Non-Provisional application Ser. No. 18/696,192 filed Mar. 27, 2024 which claims priority to PCT US23/73011 filed Aug. 28, 2023, which claims priority to U.S. Provisional Application No. 63/401,374 filed Aug. 26, 2022 and U.S. Provisional Application No. 63/466,733 filed May 16, 2023; and is a Continuation In Part of U.S. application Ser. No. 18/446,037 filed Aug. 8, 2023 which is a continuation of U.S. application Ser. No. 17/672,483 filed Feb. 15, 2022. The disclosures of the prior applications are hereby incorporated by reference herein in their entirety.

### BACKGROUND OF THE DISCLOSURE

### 1. Field of the Disclosure

The present invention relates to a gas purification and processing apparatus and method. More specifically, it relates to an apparatus and method of gas purification utilizing an amine unit and downstream reduction unit including eductors to purify carbon dioxide from an acid gas stream and generate elemental sulfur.

### 2. Description of the Related Art

The demand for natural gas has increased exponentially over the past few decades and continues to increase. Gas production has traditionally been sourced from sweet gas fields which produce natural gas with little to no undesirable constituents. However, as gas demand increases, natural gas production is increasingly being extracted from fields containing sour natural gas which includes undesirable constituents, such as hydrogen sulfide and carbon dioxide, that must be removed to generate natural gas suitable for consumer use and sale.

Purifying sour natural gas involves separating the natural gas from acid gas components such as CO₂ and H₂S. Conventionally, sour gas purification is performed in stages by discrete gas treatment systems. For example, sour natural gas may be purified by an amine system which serves as a first stage and a second stage to manage the generated tail gas stream. During the first stage, the amine system may generate purified natural gas, but the amine system also may generate a tail gas that is predominately CO₂ and H₂S, which requires second stage treatment, destruction or disposal. A redox system may be utilized in the second system stage to purify the CO₂ and reduce the H2S as solid sulfur.

Due to different operating conditions, amine and redox systems are separate systems that are not easily integrated. More specifically, amine regeneration and bubble column designs for liquid redox have conflicting operating pressures requirements. For example, the effluent tail gas of the amine regeneration system is generally of too low a pressure to flow through a bubble column. As a result, before the tail gas may be processed by a redox system, the tail gas must be compressed by at least one or a series of compressors up to the operable influent pressure for the redox system. Second, amine systems are not always near redox systems so the tail gas must be transported via pipes over a distance to an available redox system. This transportation may lead to additional pressure losses through the pipe in transferring the gas to the redox unit. As a result, the tail gas pressure must also be boosted utilizing compressors.

Incompatible integration of standard amine and redox systems leads to process inefficiencies. Compressor use prior to the tail gas entering the redox contactor causes increases in the initial capital expenses for the redox system, and the gas transportation and compressor operation causes increased maintenance and operating expenses.

Therefore, there is a need for a more efficient, integrated amine and redox gas purification system capable of sweetening natural gas, with the removal of CO₂ and H2S, generating clean sulfur, while obviating the need for compression of the amine tail gas and heating the redox contactor and/or redox reagent.

### BRIEF SUMMARY OF THE DISCLOSURE

A gas treatment system, according to this disclosure, includes an amine unit connected upstream of a redox unit utilizing an eductor apparatus. This method redox unit may operate at the same or substantially less pressure. As a result, effluent tail gas from the amine regeneration unit may be transferred to the redox unit without further compression. Therefore, the initial capital expenditure as well as ongoing operations and maintenance costs are reduced.

In some aspects, the techniques described herein relate to a gas treatment system for treating an acid gas stream including CO2, the system including: an eductor configured to contact the acid gas stream with a primary stream including an aqueous metal chelant and release an eductor outlet stream including CO2 gas and the aqueous metal chelant; a chamber connected to an outlet of the eductor, the chamber configured to receive the eductor outlet stream, the chamber including an upper portion sidewall defining a gas outlet and a primary stream outlet such that the chamber is configured to separate the eductor outlet stream into a CO2 gas stream and the primary stream; and a motive fluid inlet in the eductor, the primary stream extending from the motive fluid inlet to the primary stream outlet such that the primary stream is configured to circulate the aqueous metal chelant from the chamber to the eductor.

In some aspects, the techniques described herein relate to a system, further including: an upper zone in the chamber, the upper zone configured to hold a gaseous portion separated from eductor outlet stream; the eductor is a first eductor, the motive fluid inlet is a first motive fluid inlet and the eductor outlet is a first eductor outlet; and a second eductor including a second motive fluid inlet, a second eductor inlet, and a second eductor outlet, the motive fluid inlet connected to the primary stream, the second eductor inlet and the second eductor outlet connected to the chamber, the second eductor inlet configured to withdraw the gaseous portion from the chamber, contact the gaseous portion with the primary stream and discharge a second eductor outlet stream, via the second eductor outlet, into the chamber.

In some aspects, the techniques described herein relate to a system, further including: at least one weir in the chamber, the at least one weir positioned between the first eductor outlet and the second eductor outlet, the at least one weir configured to allow flow of the first eductor outlet stream and the second eductor outlet stream under the at least one weir.

In some aspects, the techniques described herein relate to a system, wherein the at least one weir includes perforations for blending, within the chamber, of the first outlet stream and second outlet stream.

In some aspects, the techniques described herein relate to a system, further including: an amine unit upstream of the eductor, the amine unit generating the acid gas stream, and the acid gas stream connected to a gas inlet of the eductor.

In some aspects, the techniques described herein relate to a system, wherein the acid gas stream includes a pressure drop between the amine unit and the eductor.

In some aspects, the techniques described herein relate to a system, wherein the amine unit is configured to operate at a higher pressure than the eductor.

In some aspects, the techniques described herein relate to a system, wherein the aqueous metal chelant stream further includes: a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a gas treatment system including: an amine unit configured to separate an influent fluid stream into a first amine effluent stream including hydrocarbons and an acid gas stream including CO2; and a reduction unit including at least one eductor and a primary stream including an aqueous metal chelant, the at least one eductor configured to contact the acid gas stream with the primary stream and generate an eductor outlet stream including a mixture of CO2 gas and the primary stream.

In some aspects, the techniques described herein relate to a system, wherein the reduction unit is configured to operate at a lower pressure than the amine unit.

In some aspects, the techniques described herein relate to a system, wherein the reduction unit further includes: a chamber configured to receive the eductor outlet stream, the chamber including a sidewall defining a gas outlet and a primary stream outlet such that the chamber is configured to separate the eductor outlet stream into a CO2 gas stream and the primary stream.

In some aspects, the techniques described herein relate to a system, further including: a motive fluid inlet in the eductor, the primary stream extending from the motive fluid inlet to the primary stream outlet such that the primary stream is configured to circulate the aqueous metal chelant from the chamber to the eductor.

In some aspects, the techniques described herein relate to a system, wherein the aqueous metal chelant stream includes metal chelants, ferric salts, ferrous salts, ferric chelants, ferrous chelants, nano-iron, colloidal iron, Fe-MGDA, HEME, organisms containing HEME, or any combination thereof.

In some aspects, the techniques described herein relate to a method of purifying CO2 gas, the method including: contacting, in an eductor, an acid gas stream with and a primary stream, including an aqueous metal chelant; releasing, from the eductor, an eductor outlet stream including CO2 gas and the primary stream into a chamber; separating, in the chamber, the eductor outlet stream into a CO2 gas stream and the primary stream including the aqueous metal chelant; and circulating the primary stream from the chamber to a motive fluid inlet of the eductor.

In some aspects, the techniques described herein relate to a method, further including: separating, in the chamber, a gaseous portion from the eductor outlet stream, wherein the eductor is a first eductor and the eductor outlet stream is a first eductor outlet stream; withdrawing the gaseous portion from the chamber via a second eductor; contacting the primary stream and gaseous portion in the second eductor; and releasing a second eductor effluent stream into the chamber via the second eductor, the second eductor outlet stream including CO2 gas and the primary stream.

In some aspects, the techniques described herein relate to a method, further including: equalizing a fluid level inside the chamber by allowing the first eductor outlet stream and the second eductor outlet stream to flow under at least one weir in the chamber.

In some aspects, the techniques described herein relate to a method, further including: receiving the acid gas stream from an amine unit upstream of the eductor.

In some aspects, the techniques described herein relate to a method, further including: allowing a pressure of the acid gas stream to drop between the amine unit and the eductor such that the amine unit releases the acid gas stream at a higher pressure than the acid gas stream is received by the eductor.

In some aspects, the techniques described herein relate to a method, further includes: providing the primary stream including the aqueous metal chelant, wherein the aqueous metal chelant includes a metal chelant, metal chelants, ferric salts, ferrous salts, ferric chelants, ferrous chelants, nano-iron, colloidal iron, Fe-MGDA, HEME, organisms containing HEME, or a combination thereof.

In some aspects, the techniques described herein relate to a method of purifying CO2, the method including: using an amine unit to separate an influent fluid stream into a first amine effluent stream including hydrocarbons and an acid gas stream including CO2; and contacting, in a reduction unit including at least one eductor, the acid gas stream with a primary stream including an aqueous metal chelant; releasing, into a chamber, an eductor outlet stream including a mixture of CO2 gas and the primary stream; and releasing, via a gas outlet, the CO2 gas from the chamber.

In some aspects, the techniques described herein relate to a method, further including: circulating the primary stream from a primary stream outlet in the chamber to a motive fluid inlet in the at least one eductor.

In some aspects, the techniques described herein relate to a method, further including: providing the primary stream including the aqueous metal chelant, wherein the aqueous metal chelant includes a metal chelant, metal chelants, ferric salts, ferrous salts, ferric chelants, ferrous chelants, nano-iron, colloidal iron, Fe-MGDA, HEME, organisms containing HEME, or a combination thereof.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 a first schematic diagram of a first embodiment, according to this disclosure, of a gas treatment unit;

FIG. 2 is a schematic diagram of second embodiment, according to this disclosure, of a gas treatment unit including an amine unit and redox treatment unit;

FIG. 3 is a schematic diagram of the redox unit, according to this disclosure, of FIG. 2;

FIG. 4 is a perspective view a reduction unit, according to this disclosure, that is included in the redox unit of FIG. 3;

FIG. 5 depicts a cut away view of the reduction unit of FIG. 4;

FIG. 6 depicts an example of an eductor of the reduction unit in FIGS. 3-5;

FIG. 7 is a flow diagram of an embodiment, according to this disclosure, of a method of making a gas treatment unit; and

FIG. 8 depicts a flow diagram of an embodiment, according to this disclosure, of purifying a gas utilizing the gas treatment systems of FIGS. 1-3.

### DETAILED DESCRIPTION OF THE INVENTION

Certain terminology is used in the following description for convenience only and is not limiting. As used herein, the words “connected” or “coupled” are each intended to include integrally formed members, direct connections between two distinct members without any other members interposed therebetween and indirect connections between members in which one or more other members are interposed therebetween. The terminology includes the words specifically mentioned above, derivatives thereof, and words of similar import.

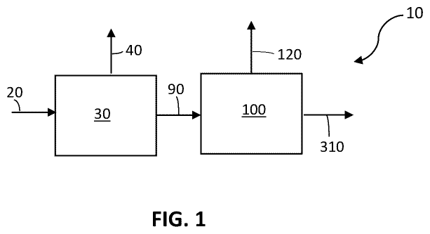

Like numbers are used to indicate like elements throughout. Elements, components, and/or features that are discussed herein with reference to one or more of FIGS. 1-4 may be included in and/or utilized with any of FIGS. 1-4 without departing from the scope of the present disclosure. FIGS. 1-4 provide an example of embodiments of a gas treatment unit 10 and methods according to the present disclosure. The gas treatment unit or system 10 and methods may be utilized, for example, to treat hydrocarbon containing gases for the generation of purified or sweetened natural gas, sulfur, CO₂, liquid water and intermediaries such as steam and hydrogen sulfide, etc. While the treatment of a hydrocarbon containing gas stream such as sour natural gas extracted from a well is discussed herein, the reduction oxidation (“redox”) unit 100 and methods 600 and 800, according to the present disclosure, may also be used to treat other gas streams including landfill gases, industrial gases and power generation (i.e., oil processing by-products) gases and for the purposes of purifying CO₂, hydrogen sulfide and sulfur. Also, it is recognized that the influent gas treatment parameters, desired treatment/purification standards and operating conditions may allow for modifications to unit 10 and methods 700, 800 by adding or removing elements and/or treatment steps.

FIG. 1 is a schematic diagram of an exemplary embodiment of a gas treatment system 10 according to the present disclosure. As shown, gas treatment unit 10 includes an integrated amine and redox processing system which may be utilized to treat hydrocarbon containing gases as well as purification of CO₂. More specifically, unit 10 includes an amine unit 30 connected to a downstream redox unit 100. Amine unit 30 may purify natural gas and related hydrocarbon gases and generate an acid or tail gas stream 90. Redox unit 100 receives tail gas stream 90 and purifies any CO₂ by removing the H2S contained in stream 90.

Amine unit 30 is configured to receive an influent gas stream 20 and produce at least two streams including a first amine effluent stream or a purified hydrocarbon gas stream 40 and a second amine effluent stream, which is the tail gas stream 90. The influent gas stream 20 may include hydrocarbon gas from various sources including industry, by-products of oil processing and sour natural gas extracted from a well, etc. In either case, the influent gas stream 20 may include various concentrations of constituents such as hydrocarbons, H₂S and CO₂. The hydrocarbon gas stream 40 may be a sweetened or purified natural gas stream, which may meet the requirements for natural gas gathering or require additional processing before the requirements are met. The tail gas stream 90 may be a fluid including a gas, vapor and combination thereof and may include constituents such as CO₂, H₂S and H₂O vapor. Also, the tail gas 90 is released by the amine unit 30 at an amine still pressure.

Redox unit 100 may be connected directly downstream from the amine unit 30 and receives the second amine effluent or tail gas stream 90 at a pressure equal to or less than the amine still pressure. Next, redox unit 100 may treat any toxic H₂S within the stream 90 and leaving a predominately CO₂ from stream 90. As a result, the redox unit 100 may produce a purified CO₂ gas stream 120 as well as an elemental sulfur stream 310.

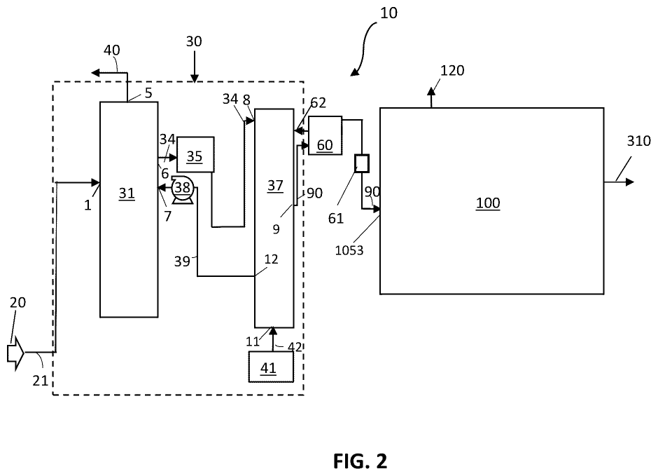

FIG. 2 provides a schematic diagram of another embodiment, according to this disclosure, of the hydrocarbon treatment system 10. The amine unit 30 is shown in a dashed line box upstream of the redox unit 100 with a water separation unit 60 therebetween. It is understood that the influent gas treatment parameters, desired treatment/purification standards and operating conditions may allow for modifications to unit 10 by adding or removing elements within the dashed line boxes.

As shown in FIG. 2, amine unit 30 may include amine contactor 31 and amine reagent regeneration unit 37. Stream 90 leaving the amine unit 37 proceeds to the reduction unit 140. A water separation system 60 is downstream from amine reagent regeneration unit 37, but upstream of the reduction unit 140. The operating and capital expenses are reduced by integration of the amine and redox processing obviating the need for the compression of the tail gas stream 90 before stream 90 enters the redox portion of the system 10.

The initial chemical processing (i.e. contacting of stream 20 with a reagent) of the influent gas stream 20 may occur in the amine contactor 31. The amine contactor 31 may be connected to the source of stream 20 with any physical processing, such as compression and filtration, therebetween.

The amine contactor 31 may have various configurations, most commonly designed as a packed tower and/or tray, etc. and gas inlet port 1, treated gas outlet port 5, and rich amine outlet port 6. Influent gas stream 20 may enter contactor 31 via conduit 21 and gas inlet port 1. A liquid amine reagent stream 39, which may include monoethanolamine (MEA), methyldiethanolamine (MDEA) and/or diethanolamine (DEA), etc. may enter the contacting unit 31 via an inlet port 7. The separated, purified and/or concentrated hydrocarbon gas stream or first amine effluent stream 40 may be released by the contactor 31 via port 5. A contacted amine reagent stream 34, which has absorbed the influent gas stream 20 constituents including CO₂ and H₂S, etc., may be released from the contactor 31 via port 6.

The contacted amine reagent stream 34 flows downstream to a flash tank 35 where it is prepared for entry into the amine reagent regeneration unit 37. A suitable flash tank as is known to one of ordinary skill in the art may be utilized.

The amine reagent regeneration unit 37 is configured to receive the contacted amine reagent stream 34 via port 8, and a water vapor stream 42 via port 11 from reboiler 41. The scrubbing or stripping process then allows the CO₂ and H₂S to separate from the amine reagent. The regenerated amine reagent stream 39 is released from scrubber 37 via port 12. The separated constituents including CO₂, and H₂S, etc. as well as water vapor are released from scrubber 37, as stream 90, via outlet port 9.

A suitable amine reagent regeneration unit 37 may include strippers or scrubbers such as countercurrent, bi-directional trays and/or packed towers, etc. Depending on the type of unit 37 and reboiler 41 selected, the unit 37 operational pressure may be within the range of approximately 15-25 PSI. In this case, the tail gas stream 90 pressure range and connection pressure may also be approximately 15-25 PSI. The operational temperature and pressure of unit 37 may be controlled with back flow control valve 61.

Pump 38 transfers the amine reagent stream 39 into the contacting unit 30 via port 7. The amine reagent stream 39 is then used by the contactor 31 to separate the constituents of CO₂ and H₂S from the influent gas 20 and generate effluent gas 40.

After leaving the scrubber 37, the tail gas stream 90 including CO₂, H₂S and water vapor, etc. travels downstream to water separation system 60 which may include a condenser (i.e. forced air and/or water cooled) or any other suitable unit to remove the water vapor while the pressure of the first tail gas stream 90 remains fairly constant. When the fluid is condensed, liquid water or condensate stream 62 is produced and travels upstream to unit 37. Also, the condensed tail gas stream 90 flows downstream to redox unit 100. As shown, stream 90 may flow directly from the amine reagent regeneration unit 37 to the water separation system 60 and then directly to redox unit 100 as the condensed tail gas stream 90.

Alternatively, it is noted that tail gas stream 90 may flow directly downstream to redox unit 100 without passing through the water separation system 60.

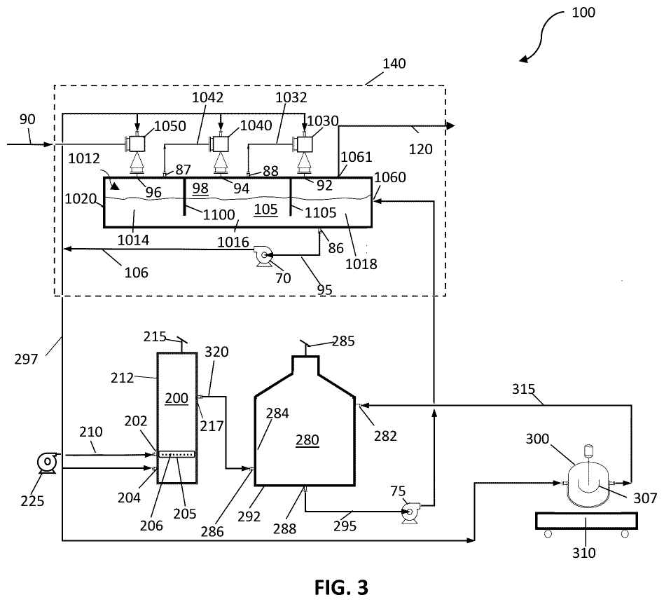

Redox unit 100, as depicted in FIG. 3, may treat the stream 90 and generate purified CO₂ gas stream 120. Further, unit 100 may treat H₂S gas contained in stream 90 and generate elemental sulfur stream 310. Unit 100 may include a reduction unit 140, an oxidation unit 200, a collection tank 280, a sulfur removal unit 300, purified CO2 gas stream 120, air inlet 202, vent 215, primary stream 106, secondary stream 297, transfer stream 295, desulfurized stream 315, regenerated stream 320, pumps 70, 75, and redox reagent 95. Reduction unit 140 includes reduction chamber 1012 and eductors 1030, 1040, 1050.

Redox unit 100 may receive stream 90 directly from the amine unit 30 as a continual or intermittent stream at little to no pressure without the need for compression as the gas stream 90 moves from unit 30 to unit 100. More specifically, as stream 90 moves from unit 37 to unit 140, the pressure may drop, and there is no need for added compression of stream 90. That is, amine regeneration unit 37 may operate at a first pressure which is greater than a second pressure at which reduction unit 140 may operate.

Redox unit 100 utilizes an aqueous redox reagent 95 that is a reducing agent such as an aqueous metal chelant and may include one or more of ferric salts, ferrous salts, ferric chelants, ferrous chelants, nano-iron, colloidal iron, Fe-MGDA (ferric/ferrous methylglycinediacetate) such as Alanine, n,n-bid, (carboxymethyl) iron complex (CAS 547763-83-7), natural heme separated from natural organisms, whole organisms such as bacteria or yeast which include heme, and biosynthesized heme, etc. If the reagent 95 includes biosynthesized heme, a metallic porphyrin, such as iron porphyrins, may be preferred. Biosynthesized heme may be produced through recombinant DNA and genetic engineering of yeast. An example the biosynthesis of heme is described in U.S. Pat. Nos. 9,938,327 and 10,689,656 issued Apr. 10, 2018 and on Jun. 23, 2020, respectively, both of which are entitled “Expression Constructs and Methods of Genetically Engineering Methylotrophic Yeast”, and the contents of both applications are herein incorporated by reference in their entirety.

Reagent 95 is provided to reduction unit 140 as a component of transfer stream 295 which is an aqueous stream. Suitable concentrations of iron, in any form discussed above, within transfer stream 295 range from 4,000 mg/l to 20,000 mg/l. The concentration may be increased or decreased depending upon the concentration of the H₂S within stream 90, system performance, and hydration.

As the reagent 95 is circulated through unit 100, the ability of the reagent to react changes. When reagent 95 is able to react, the reagent 95 is referred to as available. On the other hand, a percentage of reagent 95 may be unavailable, due to previous contact with H₂S in stream 90, and must be regenerated prior to subsequent use. For example, due to contacting in the reduction unit 140, secondary stream 297 as well as primary stream 106 may include both available and unavailable reagent 95, but after processing in oxidation unit 200, the reagent 95 in regenerated stream 320 is entirely or substantially available.

Unit 100 includes multiple streams 106, 295, 297, 315, 320 as well as pumps 70, 75 to continually recirculate reagent 95 throughout unit 100. Pump 75 may be positioned downstream of tank 280 to receive transfer stream 295 from the collection tank 280 and propel transfer stream 295 to reduction chamber 1012 via inlet 1060. Primary stream 106 is stored in chamber 1012 and pump 70 transfers primary stream 106 to the eductors 1030, 1040, 1050. Therefore, primary stream 106 extends from outlet 86 to first, second and third motive fluid inlets 1054, 1044, 1034 such that the primary stream is circulated from chamber 1012 to the eductors 1050, 1040, 1030. Secondary stream 297 branches from primary stream 106, and pump 70 transfers secondary stream 297 to oxidation unit 200, and sulfur removal unit 300. Pump 70 also provides the motive force to oxidation unit 200 and for movement of desulfurized stream 315 from sulfur removal unit 300 to collection tank 280. Regenerated stream 320 cascades to collection tank 280 by gravity. Thus, one portion of the secondary stream 297 is influent to oxidation unit 200 and another portion of the secondary stream 190 is influent to the sulfur removal unit 300. Pumps 70, 75 may be a centrifugal or vertical pump or any other suitable pumps.

Tank 280 collects, stores and equalizes the reagent 95 for further circulation through the unit 100. As such, tank 280 may include a reservoir surrounded by a sidewall 292 with multiple inlets and outlets including, regenerated inlet 286, desulfurized inlet 282, vent outlet 285 and transfer stream outlet 288. The regenerated inlet 286 may receive regenerated stream 320 from oxidation unit 200. Desulfurized inlet 282 receives desulfurized stream 315 from sulfur removal unit 300. Vent outlet 285 allows tank 280 to release air for pressure equalization. Outlet 285 allows transfer stream 295 to leave the tank 280 and flow to the pump 75 for transfer to reduction chamber 1012.

Due to the continual recirculation of streams 295, 297, 315, 320, each stream 295, 297, 315, 320 may include varied levels of available or unavailable reagent 95 and elemental sulfur. Stream 320 may include the highest concentration of available reagent 95 in unit 100 as well as elemental sulfur. On the other hand, desulfurized stream 315 may include the lowest concentration of elemental sulfur within unit 100 as well as both available and unavailable reagent 95.

Tank 280 receives streams 320, 315, respectively, from the effluent of the reduction unit 140, oxidation unit 200 and sulfur removal unit 300. Therefore, in addition to storing the reagent 95, tank 280 serves as an equalization vessel for the mixing or combining of the streams 320, 315. The equalization within the tank 280 averages sulfur, available reagent and unavailable reagent concentrations. As a result, transfer stream 295, leaving tank 280, may include solid sulfur, unavailable reagent 95, and an effective concentration of available reagent 95 for contacting in the reduction unit 140.

The reduction unit 140 is configured to receive and contact stream 90 which may include H₂S and CO₂ with primary stream 106 and generate a purified CO₂ gas stream 120. When primary stream 106 contacts the H₂S in stream 90, the reagent 95 reacts with the H₂S and sulfide ions combine to form elemental sulfur. For example, when reagent 95 is an iron chelant, a reduction reaction occurs as follows:

Reduction: H₂S(g)+2Fe³⁺(aq)→2H⁺(aq)+S(s)+2Fe²⁺(aq).

As a result, the H₂S is removed from gas stream 90 and a purified CO₂ gas stream 120 is produced.

Reduction unit 140, as shown in FIGS. 3-5 includes a chamber 1012, primary stream 106, pump 70, first eductor 1050, second eductor 1040 and third eductor 1030, a first weir 1100, second weir 1105, a treated gas stream outlet 1061 and primary stream outlet 86, and gas outlets 87, 88. It is noted that the concentration of H₂S in stream 90 may be reduced with at least one eductor 1050 and the additional eductors 1040, 1030 may be included for further reduction in H₂S concentrations.

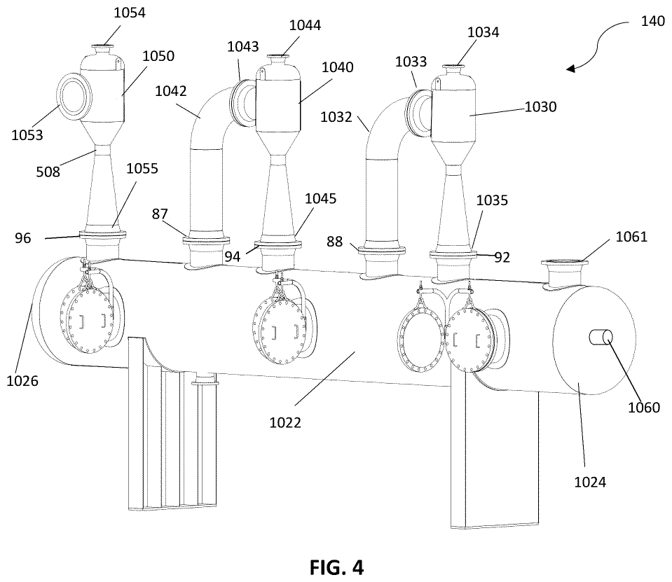

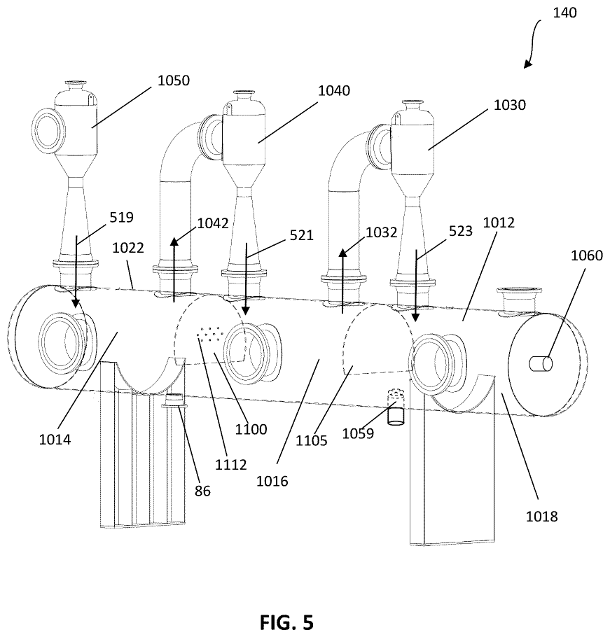

As shown in FIGS. 4 and 5, chamber 1012 is hollow and defined by sidewall 1020 including central sidewall 1022 (FIG. 4) and lateral sidewalls 1024, 1026 (FIG. 4). The central sidewall 1022 includes openings 92, 94, 96 (FIG. 4) corresponding to the attachment of eductor 1030, 1040 and 1050 contacted fluid outlet nozzle 1035, 1045 and 1055. FIG. 5 with transparent sidewall 1020 which is depicted as a dashed line to denote this, and weirs 1100, 1105 in the interior of chamber 1012 The first weir 1100 is positioned between the first and second eductors 1050, 1040. The second weir 1105 is positioned between the second and third eductors 1040, 1030. The weirs 1100, 1105 are spaced apart such that the chamber is divided into subchambers 1014, 1016, 1018.

As shown in FIGS. 3 and 5, both the first and second weirs 1100, 1105 may abut the central sidewall 1022, but each weir 1100, 1110 is spaced apart from the bottom of central sidewall 1022. The space between each weir 1100, 1105 and the bottom of sidewall 1022, allows subchambers 1014, 1016, 1018 to be in fluid communication with the liquid primary stream 106, within chamber 1012, being permitted to freely flow from between the chambers in a downstream or upstream manner. Also, this use of the weirs 1100, 1105 within chamber 1012 permits first, second and third eductor outlet streams 519, 521, 523 to blend within chamber 1012 and form primary stream 106. Further blending within chamber 1012 may be accomplished by perforations 1112, which are through holes, in one or both of weirs 1100, 1105.

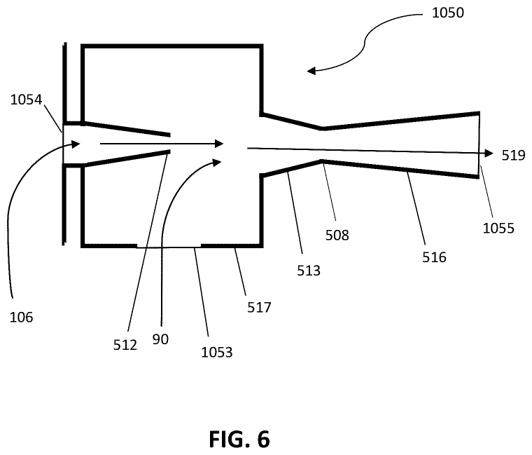

FIG. 6 depicts eductor 1050 which may also be utilized as eductors 1040, 1030. Eductor 1050 includes motive fluid and aqueous inlet 1054, an entrained gas inlet 1053, outlet nozzle 1055, a chamber 517, converging length 513, narrowing throat 508, and a diverging length 516. During operation, the narrowing throat 508 causes extreme turbulence due to the Venturi effect. As a result, the primary stream 106, which acts as the motive fluid, and influent gas stream 90 are completely and thoroughly mixed to form eductor outlet stream 519. In reduction unit 140, primary stream 106 is an aqueous fluid with solid sulfur suspended therein. During operation, pump 70 forces primary stream 106 into the eductor 1050 and entrains the influent gas stream 90 into the eductor 1050. Once inside eductor 1050, contacting between stream 106 and stream 90 occurs in chamber 517. Next, converging length 513 and narrowing throat 508 cause such turbulence that the contacting continues through the diverging length 516, beyond outlet nozzle 1055 and in chamber 1012.

As shown in FIGS. 3-5, first, second and third eductors 1050, 1040, 1030 include the narrowing throat 508 as well as a corresponding influent gas stream inlets 1053, 1043, 1033, primary stream inlets 1054, 1044, 1034 and eductor or contacted fluid outlet nozzles 1055, 1045, 1035 which release corresponding first, second and third eductor outlet streams 519, 521, 523. Each of the first, second and third motive fluid inlets 1054, 1044, 1034 of corresponding eductors 1050, 1040, 1030 is an aqueous inlet and connected to primary stream 106 which is recirculated, via pump 70, from subchamber 1018 of chamber 1012. First inlet 1053 of the first eductor 1050 is connected to the influent gas stream 90. Second eductor inlet 1044 of the second eductor 1040 is connected to opening outlet 87 through which eductor 1040 withdraws second eductor gas stream 1042 from the upper portion of subchamber 1014. Third eductor inlet 1033 of the third eductor 1030 is connected to outlet 88 through which eductor 1030 withdraws third eductor gas stream 1032 from subchamber 1016.

Chamber 1012 includes an upper zone 98 (FIG. 3) above a fluid zone 105. As eductor outlet streams 519, 521, 523 enter chamber 1012, the gaseous portion separates from the liquid and solid sulfur. The upper zone 98 holds the gaseous portion which may be a mixture of acid gas and CO₂ that rises to upper zone 98 and is contained via sidewall 1020. The gaseous portion may be simultaneously withdrawn from chamber 1012, via eductors 1040, 1030, as streams 1042, 1032, respectively.

Fluid zone 105 may include a mixture of the various streams 295, 519, 521, 523 that enter chamber 1012. As elemental sulfur is being produced via the reduction reaction, primary stream 106, within zone 105, includes elemental sulfur as well as available and unavailable reagent 95.

Within each eductor 1050, 1040, 1030, primary stream 106, including the reagent 95, contacts the corresponding influent gas stream 90, second eductor gas stream 1042, or third eductor gas stream 1032. Pump 70 and eductors 1050, 1040, and 1030 provide the motive force which entrains the corresponding streams 90, 1032, 1042. Within the first eductor 1050, gas stream 90 is contacted by primary stream 106, and the first eductor 1050 discharges first eductor outlet stream 519 into subchamber 1014. Inside the second eductor 1040, stream 1042 is contacted by stream 106, and the second eductor 1040 discharges second eductor outlet stream 521 into subchamber 1016. Inside the third eductor 1030, stream 1032, which originates from subchamber 1016, is contacted by primary stream 106, and the third eductor 1030 discharges third eductor outlet stream 523 into subchamber 1018.

Due to the occurring reduction reaction, first, second and third eductor outlet streams 519, 521, 523 include a mixture of elemental or solid sulfur, gas and available and unavailable reagent 95. However, the concentration of H₂S from the influent gas stream 90 decreases as it moves through each eductor 1050, 1040, 1030 in sequence. For example, the first eductor outlet stream 519 may contain significantly less H₂S than the influent gas stream 90. After treatment in the first eductor 1050, the H₂S concentration of the separated second eductor gas stream 1042 still may require treatment for safe use in energy production or transport. To further eliminate H₂S from stream 90, the processing of stream 90 may occur sequentially through the remaining second and third eductors 1040, 1030, which further decreases the H₂S concentration. Due to the use of multiple eductors as well as an iron or metal chelant concentration of about 10,000 mg/l, the H₂S concentration of the purified effluent/CO₂ gas stream 120, released via gas outlet 1061, may be reduced to 20 ppm or below. That is, at least one eductor 1050 is required to reduce the level of H₂S in the influent gas stream 90, but additional eductors 1040, 1030 may be added.

Treated gas outlet 1061, aqueous inlet 1060 are positioned in the sidewalls 1022, 1024 of subchamber 1018 while primary stream outlet 86 is positioned in sidewall 1022 of subchamber 1014. The gas outlet 1061 may be positioned at a relatively higher position than outlet 86 and inlet 1060. As shown in FIGS. 3-5, gas outlet 1061 is defined by central sidewall 1022, and inlet 1060 is defined by sidewall 1024. Further, outlet 86 is defined by sidewall 1022 and may be at a position lower than inlet 1060 or outlet 1061. Additionally, outlet 86 may include a flow device 1059 (FIG. 5) which inhibits vortexing and gas carry under.

Once treated gas stream 120 exits subchamber 1018 through outlet 1061. Next, stream 120 may be transported for further reduction of other contaminants, energy production and/or other use.

The sulfur removal unit 300 receives a secondary reagent stream 297, which branches from primary stream 106, downstream of pump 70. As shown in FIG. 3, sulfur removal unit 300 may include centrifuge 307 which releases solid sulfur stream 310 into a bin or rollaway. Instead of or in addition to the centrifuge 307 other suitable separation apparatus may be utilized including a bag filter, filter press, settling tank, drying bed or any combination thereof. The aqueous effluent of the sulfur removal unit 300 includes desulfurized stream 315 which is returned to the tank 280 for recirculation within the unit 100.

The oxidation unit 200 is configured to regenerate the unavailable reagent 95 by oxidizing secondary stream 297, which branches from stream 106 downstream of pump 70, with an oxidizing stream 210. A suitable oxidizing stream 210 includes air, oxygen, ozone or any combination thereof, etc. In this embodiment according to the disclosure, the oxidizing stream 210 is air which is provided via air inlet 202.

The regeneration unit 200 may include inlets 202, 204, vent 215 and outlet 217. The oxidizing stream 210 is pumped via blower 225 into the regeneration unit 200 via inlet 202. Secondary stream 297 enters unit 200 via inlet 204. Within unit 200, the oxidizing stream 210 mixes with stream 297 including available reagent 95, and assuming and iron chelant is utilized as the reducing agent, a reaction occurs as follows:

Oxidation: 2H⁺(aq)+2Fe²⁺(aq)+0.5O₂(g)→2 Fe³⁺(aq)+H₂O(l).

That is, the iron chelant is regenerated and ready for reuse in reduction unit 140.

Suitable regeneration units 200 may include a co-current bubble column, or countercurrent packed tower, etc. Further, inlet 204 may include a gas distribution device 206 such as diffuser or sparger that includes perforations for distributing the oxidizing stream 210 across the width of unit 200.

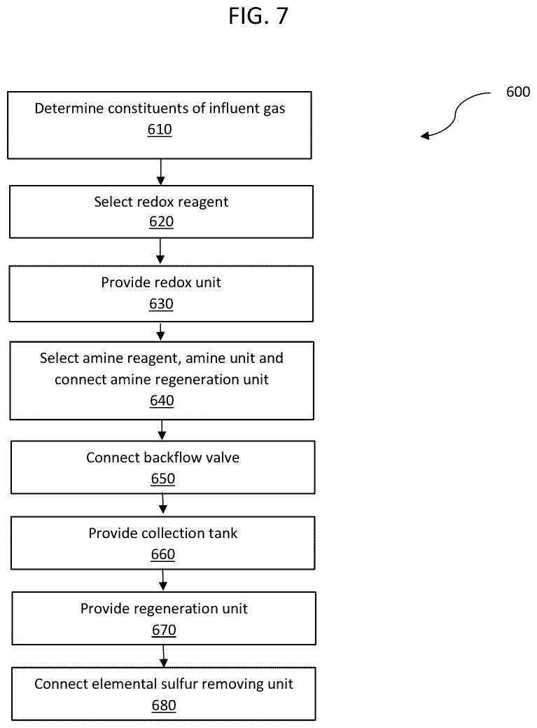

An embodiment, according to this disclosure, includes method 600 of making the system 10 is shown in FIG. 7. The composition of the hydrocarbon gas stream may vary among sources such as industrial and well. Initially, in step 610, the influent gas stream 20 composition is determined. For example, the concentration of CO₂ and H₂S as well as any other constituents may be determined.

Step 620 includes selecting a suitable redox reagent 95 for the influent gas stream 20. The redox reagent may be chosen from the examples provided above.

Step 630 includes providing the reduction unit 140 as described above. This may be accomplished by determining the number of eductors 1050, 1040, 1030 required to meet the desired H₂S removal as well as providing the reduction unit 140. Factors which may be considered are the size of eductors 1050, 1040, 1030 as well as the type and operating parameters. These determinations may be based on the selected reagent and the concentrations of CO₂ and H₂S found in the influent gas stream 20.

The reduction chamber 1012 and weirs 1100, 1105 may be formed of materials such as fiberglass, stainless steel and/or plastic, etc. by methods known in the art.

Eductors 1050, 1040, 1030 may be attached to chamber 1012 preferably by bolts or other suitable methods may be used such as welding and/or claims, etc.

Next, in step 640, the amine unit 37 and amine reagent may be provided such that unit 37 is capable of providing tail gas stream 90. As a result of eductor 1050 receiving stream 90 from unit 37, a suitable unit 37 may be selected without consideration of the operating pressure of both units 37, 140. More conveniently, unit 37 may be selected from any suitable amine generation unit 37. That is, the amine regeneration unit 37 may be selected based on factors such as effectiveness in regenerating the amine reagent as well as capital and maintenance costs.

Further, an amine contactor 31 and suitable amine reagent are provided, and the amine contactor 31 is connected upstream from the amine reagent regeneration unit 37.

In step 650, the backflow valve 61 may be provided and connected to stream 90. Valve 61 may be any suitable control valve such as sliding stem globe or segmented ball valve and may be connected to stream 90 via methods known in the art.

If a water separation unit 60 is not provided, it is noted, that step 640, may alternatively include connecting the unit 37 directly upstream of reduction unit 140 with valve 61 therebetween.

In step 660, collection tank 280, as described above, is provided. The collection tank may be formed or fiberglass, stainless steel, and/or plastic, etc. and by methods known in the art. Preferably, the size of the collection tank should include a large enough volume to hold surges from chamber 1012 and unit 200.

In step 670, to conserve the redox reagent, the redox reagent regeneration unit 200 with blower 225, as discussed above, may be provided and connected to secondary stream 297. Further, the outlet 217 of unit 200 may be connected to tank 280 via regenerated stream. Unit 200 may be formed of fiberglass, stainless steel and/or plastic, etc. by methods known in the art. Blower 225 may be any blower with suitable strength to force oxidizing stream 210 into unit 200.

If the influent gas stream 20 contains H₂S, in step 680, sulfur removal unit 300, as described above, may be provided and connected to secondary stream 297 as well as the collection tank 280 via desulfurized stream 315.

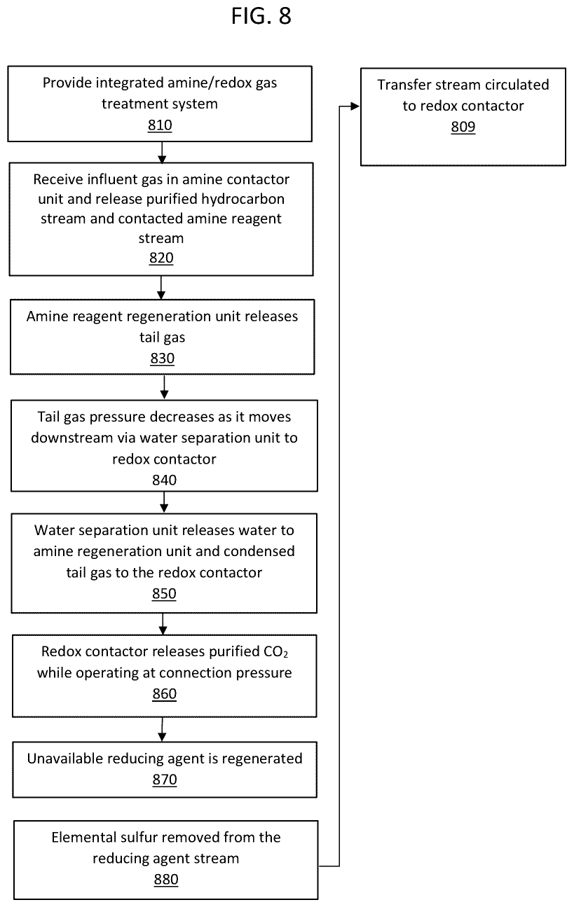

FIG. 8 depicts an embodiment, according to the present disclosure, of method 800 of purifying CO₂ and/or elemental sulfur from influent hydrocarbon gas stream 20. Initially, in steps 810-830 processing occurs in the amine unit 30. In Step 810, system 10, as discussed above and provided in FIGS. 1-3, is provided. Next, in step 820, the influent gas stream 20 is received by an amine contactor 31 which may release a first amine effluent stream 40 or purified hydrocarbon gas stream and a contacted reagent stream 39. Then, in step 830, the contacted reagent stream 39 is regenerated in a downstream amine reagent regeneration unit 37, and unit 37 releases tail gas stream 90.

In step 840, stream 90 moves from amine reagent regeneration unit 37 to the reduction unit 140. To conserve amine reagent stream 39, the tail gas stream 90, which may include water vapor, may be passed through a water separator unit 60. As discussed above, the water separator 60 may remove or reduce the water vapor from the tail gas stream 90 via condensing.

This step includes decreasing and/or controlling the pressure of stream 90 as it moves from unit 37 to reduction unit 140. As stream 90 moves, the pressure of stream 90 decreases due to the motive force of primary stream 106. The drop in pressure along stream 90 is controlled using back flow control valve 61. That is, valve 61 prevents the primary stream 106 from pulling stream 90 from unit 37 and decreasing the pressure of unit 37 below operational standards.

In step 850, the water stream 62 may be returned to the amine regeneration unit 37, while the condensed tail gas stream 90 moves downstream to the reduction unit 140.

In step 860, reduction unit 140 contacts primary stream 106 and tail gas stream 90 as described above. Initially, primary stream 106 is withdrawn from downstream subchamber 1014 of chamber 1012 and pumped to the eductors 1050, 1040, and 1030. As discussed above, first eductor 1050 contacts stream 106 with stream 90. Also, eductors 1040 and 1030 withdraw corresponding gas streams 1042 and 1032 from chamber 1012 and contact streams 1042 and 1032 with stream 106. As a result, redox effluent or purified CO₂ stream 120 is released from reduction unit 140 through the use of stream 106 and reagent 95.

In step 870, as described above, secondary stream 297 is oxidized in the regeneration unit 200. That is, the unavailable reagent in stream 297 is regenerated and returned to collection tank 280 via stream 320.

In step 880, as described above, elemental sulfur is removed from secondary stream 297 via sulfur removal unit 300. Stream 320 returns, as a desulfurized stream, to collection tank 280.

In step 890, transfer stream 295 is circulated to subchamber 1018 for use in reduction unit 140.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A gas treatment system for treating an acid gas stream including CO₂, the system comprising:
an eductor configured to contact the acid gas stream with a primary stream including an aqueous metal chelant and release an eductor outlet stream including CO₂ gas and the aqueous metal chelant;
a chamber connected to an outlet of the eductor, the chamber configured to receive the eductor outlet stream, the chamber including an upper portion sidewall defining a gas outlet and a primary stream outlet such that the chamber is configured to separate the eductor outlet stream into a CO₂ gas stream and the primary stream; and
a motive fluid inlet in the eductor, the primary stream extending from the motive fluid inlet to the primary stream outlet such that the primary stream is configured to circulate the aqueous metal chelant from the chamber to the eductor.

2. The system of claim 1, further comprising:
an upper zone in the chamber, the upper zone configured to hold a gaseous portion separated from eductor outlet stream;
the eductor is a first eductor, the motive fluid inlet is a first motive fluid inlet and the eductor outlet is a first eductor outlet; and
a second eductor including a second motive fluid inlet, a second eductor inlet, and a second eductor outlet, the motive fluid inlet connected to the primary stream, the second eductor inlet and the second eductor outlet connected to the chamber, the second eductor inlet configured to withdraw the gaseous portion from the chamber, contact the gaseous portion with the primary stream and discharge a second eductor outlet stream, via the second eductor outlet, into the chamber.

3. The system of claim 2, further comprising:
at least one weir in the chamber, the at least one weir positioned between the first eductor outlet and the second eductor outlet, the at least one weir configured to allow flow of the first eductor outlet stream and the second eductor outlet stream under the at least one weir.

4. The system of claim 3, wherein the at least one weir comprises:
perforations for blending, within the chamber, of the first outlet stream and second outlet stream.

5. The system of claim 1, further comprising:
an amine unit upstream of the eductor, the amine unit generating the acid gas stream, and the acid gas stream connected to a gas inlet of the eductor.

6. The system of claim 5, wherein the acid gas stream includes a pressure drop between the amine unit and the eductor.

7. The system of claim 5, wherein the amine unit is configured to operate at a higher pressure than the eductor.

8. The system of claim 1, wherein the aqueous metal chelant stream further comprises:
a metal chelant, metal chelants, ferric salts, ferrous salts, ferric chelants, ferrous chelants, nano-iron, colloidal iron, Fe-MGDA, HEME, organisms containing HEME, or a combination thereof.

9. A gas treatment system comprising:
an amine unit configured to separate an influent fluid stream into a first amine effluent stream including hydrocarbons and an acid gas stream including CO₂; and
a reduction unit including at least one eductor and a primary stream including an aqueous metal chelant, the at least one eductor configured to contact the acid gas stream with the primary stream and generate an eductor outlet stream including a mixture of CO₂ gas and the primary stream.

10. The system of claim 9, wherein the reduction unit is configured to operate at a lower pressure than the amine unit.

11. The system of claim 9, wherein the reduction unit further comprises:
a chamber configured to receive the eductor outlet stream, the chamber including a sidewall defining a gas outlet and a primary stream outlet such that the chamber is configured to separate the eductor outlet stream into a CO₂ gas stream and the primary stream.

12. The system of claim 11, further comprising:
a motive fluid inlet in the eductor, the primary stream extending from the motive fluid inlet to the primary stream outlet such that the primary stream is configured to circulate the aqueous metal chelant from the chamber to the eductor.

13. The system of claim 9, wherein the aqueous metal chelant stream comprises metal chelants, ferric salts, ferrous salts, ferric chelants, ferrous chelants, nano-iron, colloidal iron, Fe-MGDA, HEME, organisms containing HEME, or any combination thereof.
